(19) United States
(12) Patent Application Publication
(10) Pub. No.: US 2010/0141536 A1
(43) Pub. Date: Jun. 10, 2010

(54) ANTENNA

(75) Inventors: Lixia Zhang, Beijing (CN); Xiaojuan Guo, Beijing (CN)

Correspondence Address: HARNESS, DICKEY, & PIERCE, P.L.C, 7700 Bonhomme, Suite 400, ST. LOUIS, MO, 63105, US

(73) Assignee: Laird Technologies (Shenzhen), Ltd., Shenzhen (CN)

(21) Appl. No.: 12/600,560

(22) PCT Filed: May 16, 2008
(86) PCT No.: PCT/CN08/70992

§ 371 Date: Nov. 17, 2009

(30) Foreign Application Priority Data
May 18, 2007 (CN) 200710106355.9

(51) Int. Cl. H01Q 5/00; H01Q 1/24; H01Q 1/38

(52) U.S. Cl. 343/702; 343/700 MS

(57) ABSTRACT

The invention provides an antenna for wireless devices which improves matching of the main antenna element and parasitic antenna element in the antenna. The antenna of the invention comprises a main antenna element and a parasitic antenna element, the main antenna element and the parasitic antenna element being separated from each other, a matching element is connected between the main antenna element and the parasitic antenna element, with an end of the matching element being electrically connected to a conductor strip of the main antenna element, and the other end being electrically connected to a conductor strip of the parasitic antenna element. Optimized antenna performance can be achieved by adjusting position and value of the matching element.

### TECHNICAL FIELD

The present invention relates to an antenna for mobile communication terminals, and more particularly to an inbuilt antenna capable of covering a plurality of wavebands for mobile phones or other mobile communication terminals.

### DESCRIPTION OF THE RELATED ART

With the rapid development of the mobile communications technology and the wide application of mobile wireless system, the mobile phone as a terminal of the mobile communications system is developing toward miniaturization, multi-mode (with simultaneous compatibility of GSM850/GSM900/DCS/PCS/UMTS) and high performance.

On the side of manufacturers of mobile communications terminals, the radio frequency (RF) circuit portion, the baseband portion and the digital signal-processing portion have by now achieved high-level integration, which effectively promoted the miniaturization and low production cost of the mobile communications terminal devices. However, the technology concerning the antenna portion, especially the antenna portion for mobile communication terminals, has been progressing slowly as the performance and structural dimension of the antenna portion are affected by such factors as the structure and size of the mobile communication terminal, the mounting positions of the electronic elements and the material of the housing of the mobile communication terminal, which results in relatively low integration and relatively high cost of the currently available antennas for the mobile communication terminal, and thus restricts further development of the technology of the mobile communication terminal. At the same time, with the combination of mobile communications and computer network, this problem will be increasingly salient in the future technology of the multi-mode mobile communication terminal.

On the other hand, with the ever deeper recognition of people to the harm of the electromagnetic radiation of the mobile communication terminal device on the human body, users put increasing demand on lowering the electromagnetic radiation index of the mobile communication terminal to conform to the norm of public safety under the premise that the current performance of the mobile communication terminal device is not lowered.

The antenna is an indispensably important component part in the wireless communication device and system. Although the shape and size of the antenna can be subjected to various modifications, the operation of the antenna is unexceptionally based on the principle of electromagnetic field radiation. Antenna is a conversion member between a guided wave and a free space wave. According to the electromagnetic theory, a guided wave propagating along an open-loop transmission line radiates outwardly to become a free space wave, namely electromagnetic wave.

The RF signal outputted by a radio transmitter is transmitted to the antenna via a feed line (cable), and is radiated outward by the antenna in the form of electromagnetic wave. When the electromagnetic wave arrives at the receiving location, it is received by the antenna (which receives only a very small fraction of the power), and is transmitted to a radio receiver via a feed line. Seen as such, antenna is an indispensable wireless unit for transmitting and receiving electromagnetic wave, and it is impossible to perform wireless communication without antenna.

In recent years, with the increasing use of personal wireless communication devices such as mobile phones and portable computers, the demand for miniaturized antennas is correspondingly increased. Moreover, because of the continuous development of the technology concerning integrated circuits and batteries, the size and weight of the personal wireless communication devices have decreased to a great degree in comparison with the past, there is hence a need to correspondingly decrease the size of the antenna as a component part thereof, since the reduction in size of the antenna is a very important factor in reducing the overall size of the wireless communication device. Furthermore, the size and shape of the antenna also greatly affect the aesthetic appearance and the production cost of the wireless device.

An important RF index in design of antenna is the antenna gain or antenna efficiency, and another important factor is the bandwidth of the antenna. For instance, the antenna for a mobile phone operating in PCS band has to cover a range of waveband from 1.85 to 1.99 GHz, and the antenna for a mobile phone operating in CDMA band has to cover a range of waveband from 824 to 894 MHz. Therefore, the requirement to cover the corresponding wavebands must be satisfied in designing the antennas for these wireless devices.

Antennas commonly used in wireless communication mobile terminal devices are mainly divided into two types of the external and the inbuilt. The external antennas are usually telescopic, such as the spiral antennas widely employed in mobile phones. The disadvantages of the external antenna are that the antenna cannot be integrated to the printed circuit board or the housing of the device, thus the total size of the device is increased (especially of the telescopic type); that the antenna is easily broken or bent; that the antenna specific absorptivity (the SAR value) is high; and that it is difficult to cover a broad range of waveband. The inbuilt antenna was developed in view of the disadvantages of the external antenna. The common inbuilt antennas are micro-strip antenna and belt antenna. The inbuilt antenna is characterized in that: it can be integrated to the printed circuit board and the housing, and mounted inside the mobile phone, thus no additional space is needed; it has mechanical rigidity, is not apt to be damaged; the SAR value is low; the influence of the antenna on the human body is relatively low; it is easy for the input impedance of the micro-strip antenna to be set to 50Ω, thus matching circuit or unbalance converter is not needed; mass production can be easily achieved with good repetitiveness; and small volume, low production cost and increased bandwidth can be achieved by optimization of the design parameters. In view of the aforementioned advantages of the inbuilt antenna, it has currently become the best choice for a variety of wireless communication devices such as mobile phone, etc., and will also lead the way for the development of future mobile communication devices.

Currently available inbuilt antennas that are widely applied in mobile phones are planar inversed F antenna (PTA) and monopole antenna. Although the size and volume of such inbuilt antennas can be manufactured to be extremely small, these antennas cannot excellently satisfy the requirements of RF performance and bandwidth. In order to solve this problem, solutions have been proposed by adding slots and parasitic elements to the main antenna with respect to antennas for 4-band (GSM900/DCS/PCS/UMTS or GSM850/900/DCS/PCS) mobile phones. But these solutions cannot cover all wavebands of GSM850/GSM900/DCS/PCS and UMTS, and simultaneously satisfy the requirement of RF performance.

Although the structure of a monopole plus parasitic antenna can cover a range of five bands as required, due to the restrictions of the overall size and structure of the antenna, the return loss curve of the antenna is very shallow at the low-frequency side unless a matching element is introduced into the antenna structure. This means that the impedance of the antenna is bad here, which results in a great loss. At the same time, the return loss curve of the antenna is also relatively shallow in DCS band, which means that not only the loss of the antenna is great in this band, but it also fails to cover from DCS/PCS to UMTS.

It has been proposed to further introduce a matching element into the antenna. FIG. 7 shows an antenna of such a structure. Shown in FIG. 7 are an antenna element 700 and a circuit board 706. To the lower right of the antenna element 700 are respectively an end of a main antenna 701 and an end of a parasitic antenna 702. At the top of the circuit board 706 is disposed a feed point 703, which contacts an end of the main antenna 701 via a metal leaf not shown in the figure. Adjacent to the feed point 703 is a grounding point 704, which likewise contacts an end of the parasitic antenna 702 via a metal leaf.

An inductive or capacitive matching element 705 is connected between the feed point 703 and the grounding point 704 on the circuit board 706. This makes the return loss curve of the antenna to become from the initially shallow to deep in the low-frequency band, in other words, a smaller return loss is obtained, furthermore, with the reduction of return loss, radiation efficiency of the antenna in this band is correspondingly increased. Curve 601 in FIG. 6 shows an example of return loss test result of a prior art antenna device.

However, as shown by the result, the return loss obtained by test in DCS band changes not much. Seen as such, the introduction of matching element to the transmission line of the circuit board has only limited efficacy.

### SUMMARY OF THE INVENTION

The objective of the present invention is to increase the frequency width of an antenna inbuilt in a mobile phone, improve the radiation efficiency and the return loss, therefore provide an inbuilt antenna having a bandwidth capable of covering a plurality of wavebands for mobile phones or other mobile communication terminals.

As the inventor of the present invention found upon research and experimentation, the matching between main antenna and parasitic antenna can be improved by connecting a matching element between conductor strip of the main antenna and conductor strip of the parasitic antenna, so as to improve the coupling of the two, and hence improve the frequency width, the radiation efficiency and the return loss of the antenna.

In view of the above, there is provided according to one aspect of the present invention an antenna for a wireless device, which antenna comprises a main antenna element and a parasitic antenna element, the main antenna element and the parasitic antenna element being separated from each other, wherein a matching element is connected between the main antenna element and the parasitic antenna element.

The matching element can be connected to conductor strips of the main antenna element and the parasitic antenna element.

The matching element can be an inductor, a capacitor, a high pass filter or a low pass filter, or a combination in series/parallel thereof.

Preferably, the position or the characteristic value of the matching element is adjusted so that the antenna obtains optimized characteristics.

There is provided according to another aspect of the present invention a method of matching and optimizing an antenna during the designing phase of the antenna for an wireless device, which method comprises the steps of preparing an antenna unit having a main antenna element and a parasitic antenna element that are separated from each other; providing a matching element on said antenna unit, with an end of the matching element being electrically connected to said main antenna element, and another end being electrically connected to said parasitic antenna element; sequentially changing the position and/or value of the matching element, measuring the characteristic of the antenna, and determining the optimal position and/or value of the matching element based on the measured characteristic of the antenna to optimize the matching of the antenna.

The features and effect of the present invention can be more clearly comprehended through the detailed explanations below with reference to the accompanying drawings.

### BRIEF DESCRIPTION OF THE DRAWINGS

FIG. 1A is a perspective view schematically showing an antenna according to a first embodiment of the present invention;

FIG. 1B is a plan view showing the antenna according to the first embodiment of the present invention;

FIG. 1C is a side view showing the antenna according to the first embodiment of the present invention;

FIG. 2A is a plan view showing an antenna according to a second embodiment of the present invention;

FIG. 2B is a side view showing the antenna according to the second embodiment of the present invention;

FIG. 3A is a plan view showing an antenna according to a third embodiment of the present invention;

FIG. 3B is a side view showing the antenna according to the third embodiment of the present invention;

FIG. 4A is a diagram schematically showing different positions of the matching element in a fourth embodiment of the present invention;

FIG. 4B is a data diagram exemplifying a return loss test result of the antenna according to the fourth embodiment of the present invention;

FIG. 5 is a data diagram exemplifying a return loss test result of the antenna according to a fifth embodiment of the present invention;

FIG. 6 is a data diagram showing the influence of the matching element on the characteristics of the antenna; and

FIG. 7 is a perspective view showing a prior art antenna structure.

### DETAILED DESCRIPTION OF THE PREFERRED EMBODIMENT

Preferred embodiments of the present invention are explained in detail below with reference to the accompanying drawings.

### The First Embodiment

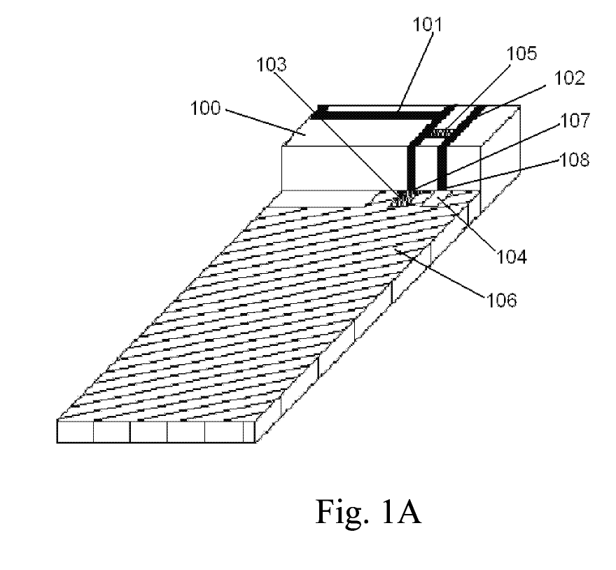

FIG. 1A is a perspective view showing the antenna according to a first embodiment of the present invention, FIG. 1B is a plan view showing the antenna according to the first embodiment of the present invention, and FIG. 1C is a side view showing the antenna according to the first embodiment of the present invention.

The antenna of the first embodiment is an inbuilt antenna for mobile phone. The antenna is a five-band antenna. To such an antenna, it is required to cover 5 operation wavebands from GSM/850/900/DCS/PCS to UMTS, namely cover most wavebands of the current 3 G communications.

As shown in FIG. 1A, the antenna body 100 is divided into three parts: a main antenna 101, a parasitic antenna 102 and a matching element 105. The main antenna 101 and the parasitic antenna 102 constitute an antenna unit. The antenna unit can be formed by flexfilm technology, and forms an opened rectangular ring. A base (not shown) made of insulating material such as plastic or resin is disposed beneath the antenna unit, and the antenna unit is attached to the base.

As shown in FIGS. 1A and 1B, to the lower right of the antenna unit are respectively an end of the main antenna 101 and an end of the parasitic antenna 102. At the top of the circuit board 106 is disposed a feed point 103, which contacts a feed foot 107 of the main antenna 101 via a metal leaf. Adjacent to the feed point 103 is a grounding point 104, which likewise contacts a grounding foot 108 of the parasitic antenna 102 via a metal leaf. Most of the upper surface of the circuit board 106 is covered by a conductive signal ground wire, which does not extend to the antenna. The feed point 103 and the grounding point 104 are spaced by a predetermined distance, for instance 5 mm, from the antenna plane.

In this embodiment the main antenna 101 is a monopole antenna having two frequency bands, with the main resonant frequency falling within the frequency range of GSM850 and GSM900, and the harmonic wave most approximate to the main resonant frequency falling within the frequency range of DCS. There is a proper proportion between the harmonic wave and the main resonant frequency, and the main antenna 101 has two branches 101₁ and 101₂.

As shown in FIG. 1C, the main antenna 101 can be substantially configured as a rectangular shape, and its two branches 101₁ and 101₂ can be designed into a longer side and a shorter side with sizes corresponding to the two main wavebands to be covered by the antenna. The relative positions of the longer side and the shorter side can be subjected to modifications. Electromagnetic coupling occurs outside the branches so as to reduce proportion between the harmonic wave and the main resonant frequency.

As shown in FIGS. 1A and 1B, the parasitic antenna 102 is located to the right of and coplanar with the main antenna 101. The parasitic antenna 102 is directly connected to the signal grounding wire via a metal leaf, is close to the shorter branch 101₂ of the main antenna 101 with a spacing thereto of about 1 mm, and resonates with the main antenna 101 in the operating frequency bands of PCS and UMTS. Naturally, resonant energy is generated from the field of the main antenna 101 through electromagnetic coupling. The parasitic antenna 102 functions as assistance to the antenna, thereby improve bandwidth and operation efficiency of the antenna.

The portion of the parasitic antenna 102 close to the circuit board 106 is substantially parallel to the main antenna 101 so as to obtain a good coupling effect. Another end of the parasitic antenna 102 slightly depart from the two branches of the main antenna 101 to another direction.

In this embodiment an inductor 105 is connected between the main antenna 101 and the parasitic antenna 102 as a matching element. One end of the inductor 105 is connected to a conductor strip of the main antenna 101, the other end is connected to a conductor strip of the parasitic antenna 102, so as to improve the matching between the main antenna 101 and the parasitic antenna 102, and to strengthen the coupling of the two. One end of the inductor 105 is indirectly connected to RF signal via the main antenna 101, and the other end is indirectly connected to the circuit board 106 via the parasitic antenna 102. The whole antenna is arranged in several two-dimensional planes, as shown in FIG. 1A.

In this embodiment, the inductor 105 is connected to a surface of the antenna body 100, and is integrated with the antenna body 100 as an integer body, unlike the case in conventional matching solutions where the matching element is placed on the conductor unit (circuit board) 106.

The inductor (matching element) 105 can be connected to the conductor strips of the main antenna 101 and the parasitic antenna 102 by such means as soldering or conductive adhesives.

In this embodiment, the main antenna 101 is a monopole antenna, but it can also be a planer inversed F antenna (PIFA) depending on conditions. In this embodiment the matching element 105 is an inductor, but it can also be a capacitor or a filter, it can be a single element, or a combination of a plurality of elements connected either in series or in parallel.

In order to verify the characteristics of the antenna according to the present embodiment, the inventor carried out comparison research on the following three types of antenna structures.
1. a structure of simple combination of monopole antenna+parasitic antenna;
2. a structure with a matching element connected between the feed point and the grounding point; and
3. a structure with a matching element connected between a monopole antenna and a parasitic antenna according to the present embodiment.

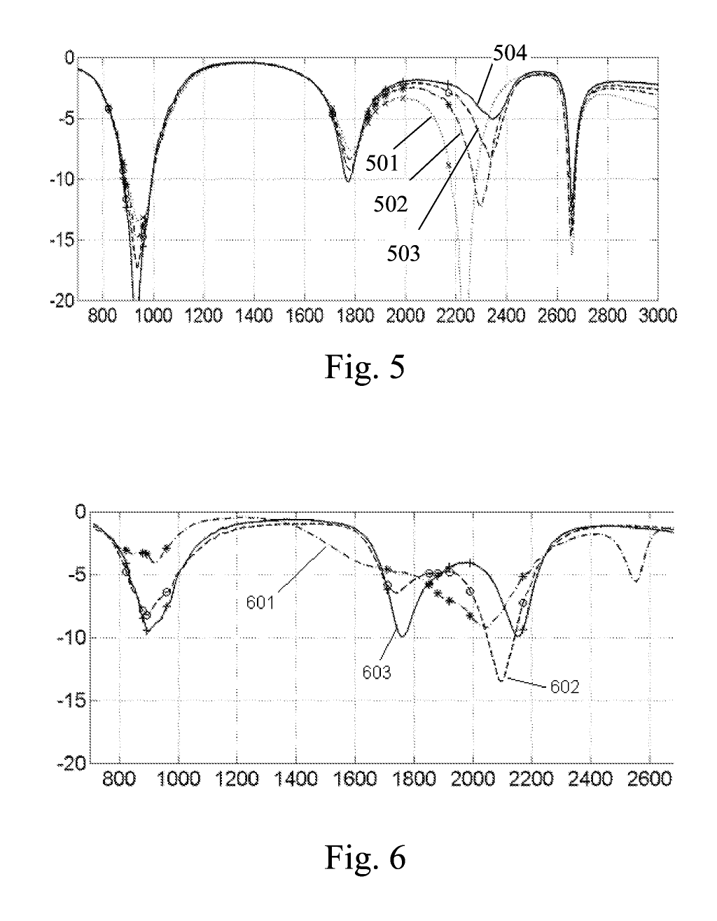

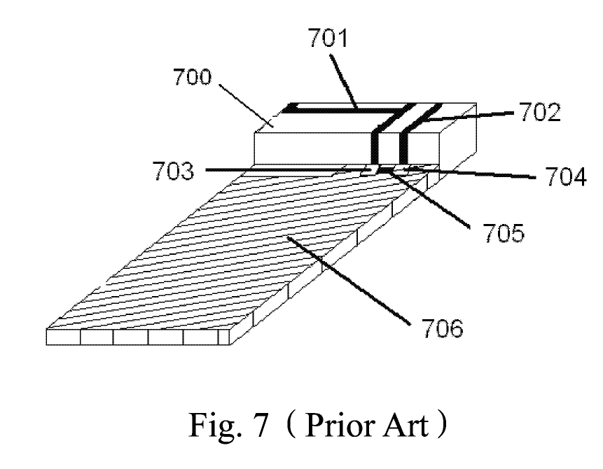

The aforementioned three structures of antenna units were prepared with the same antenna pattern. The antennas were placed on a 3-dimensional test stand in a microwave darkroom, and return losses of the antennas were measured by an Agilent™ E5062A vector network analyzer. FIG. 6 shows the test result.

The curve 601 in FIG. 6 shows the test result of the first case. As can be seen, the simple monopole antenna plus parasitic antenna cannot meet the requirement of return loss and efficiency. Although it is possible for the parasitic antenna to expand one or more operating frequency bands, the resonant frequency of the main antenna is different from the resonant frequency of the parasitic antenna, and the differentiation between the frequencies is limited, thereby the matching of antenna cannot perform well in the entire range of resonant frequency.

The curve 602 in FIG. 6 shows the test result of the second case. In this case an inductor is soldered on the transmission line located on the circuit board 106, that is to say, a matching element is added between the feed foot 107 of the antenna and the grounding point 104 on the circuit board 106. As can be seen from curve 602, the return loss curve of the antenna becomes from the initially shallow to deep in the low-frequency band, namely a smaller return loss is obtained, but the return loss obtained by test in DCS band changes not much. Seen as such, the addition of the matching element to the transmission line on the circuit board has only limited efficacy.

Curve 603 in FIG. 6 shows the test result of the third case. Here, according to the first embodiment, an inductor 105 is soldered on a surface of the antenna between the main antenna 101 and the parasitic antenna 102. As can be seen from curve 603, the return loss at the low-frequency side of the antenna becomes from the initially very shallow to very deep. Of particular attention is the fact that the performance in the DCS band which is originally very shallow is also considerably improved, as the return loss becomes remarkably from shallow to deep. With the reduction of return loss of the antenna in this waveband, the bandwidth problem of the antenna in high-frequency band is greatly improved.

### The Second Embodiment

The antenna according to the second embodiment of the present invention will be described in detail. In the following description, parts that are same to the first embodiments are not described in detail, as emphasis is put only on the different points.

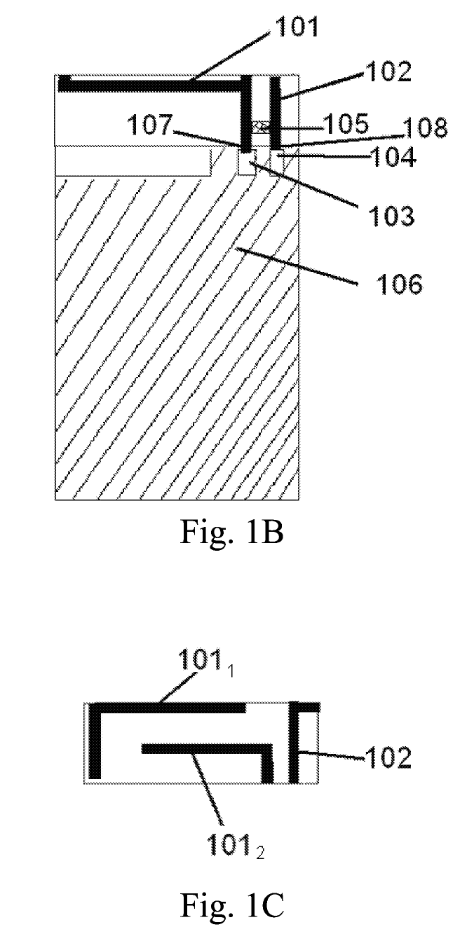

FIGS. 2A and 2B show the antenna structure according to the second embodiment of the present invention, of which FIG. 2A is a plan view showing the antenna according to the second embodiment of the present invention, and FIG. 2B is a side view showing the antenna according to the second embodiment.

The antenna according to the second embodiment comprises a circuit board 206, a main antenna 201, a parasitic antenna 202, and an inductor 205 as a matching element, the inductor 205 is connected to conductor strips of the main antenna 201 and the parasitic antenna 202. In this embodiment, the main antenna 201 is disposed on a conductor strip of the circuit board, and has branches 201₁ and 201₂ like the one in shown in FIG. 1. However, the parasitic antenna 202 is not to the right of the main antenna 201 but to the lower left of the main antenna 201, and forms a coupling with the longer branch 201₁ of the main antenna 201. Like the first embodiment, the inductor 205 is placed on an upper surface of the antenna and between the main antenna 201 and the parasitic antenna 202 to participate together in the conversion between electromagnetic wave and high-frequency current. The function of the circuit board 206 is to form, together with the main antenna 201 and the parasitic antenna 202, an opened conversion structure for electromagnetic wave and electromagnetic wave, and to provide the radiation and reception of the electromagnetic wave of the main antenna 201 and the parasitic antenna 202 with directionality.

Effect similar to the first embodiment can be achieved by the antenna structure according to the second embodiment.

### The Third Embodiment

The antenna according to the third embodiment of the present invention will be described in detail. In the following description, parts that are same to the first embodiments are not described in detail, as emphasis is put only on the different points.

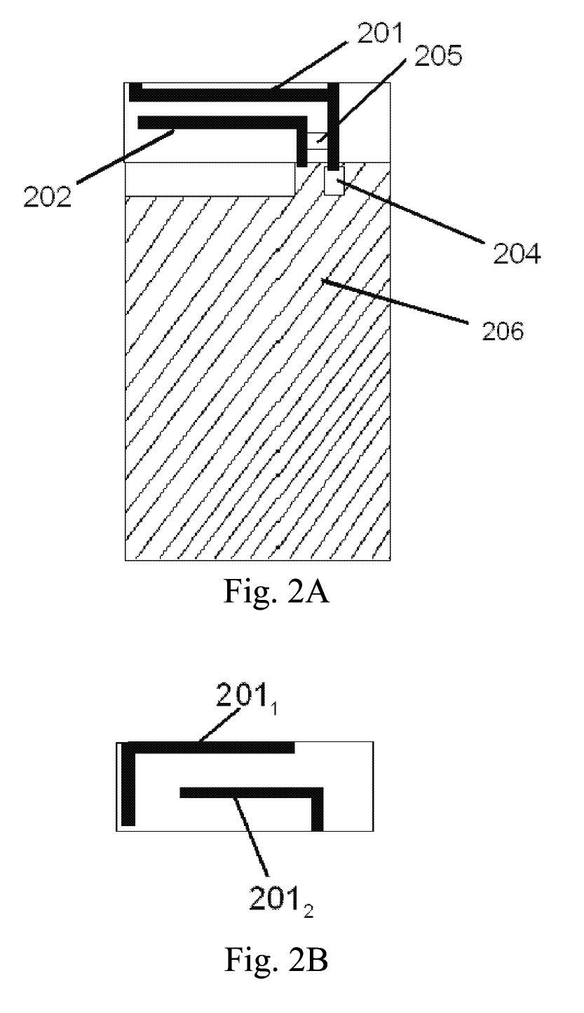

FIGS. 3A and 3B show the antenna structure according to the third embodiment of the present invention, of which FIG. 3A is a plan view showing the antenna according to the third embodiment of the present invention, and FIG. 3B is a side view showing the antenna according to the third embodiment.

Like the first embodiment, the antenna according to the third embodiment comprises a main antenna 301, a parasitic antenna 302 and an inductor element 305 as a matching element, the inductor element 305 is connected between the main antenna 301 and the parasitic antenna 302. Different from the first embodiment, in the third embodiment the main antenna 301 has a feed foot 309 and a grounding foot 308, and a feed point 310 and a grounding point 303 of a circuit board 306 are respectively connected to the feed foot 309 and the grounding foot 308 of the main antenna 301. The main antenna 301 has three branches, which fall into shorter branch 301₁ and longer branch 301₂ as seen from the feed point 310. One end of the shorter branch 301₁ is connected to the grounding point 303 for grounding of high frequency signal, the other end is connected to the feed point 310 to form an electric connection with the shorter branch 301₁. One end of the longer branch 301₂ is connected to the grounding point 303, and another end is an open end for inducing electromagnetic wave signals of the GSM850 and GSM900 system frequencies, resonance is generated when their equivalent length lie simultaneously at one-fourth the wavelength of GSM850 and GSM900 electromagnetic signals. A closed loop is formed between the feed point 310 and the grounding point 303, and the parasitic element 305 is also located to the right of the main antenna 301.

Since there is connected a matching element between the main antenna 301 and the parasitic element 302, effect similar to the first embodiment can be achieved in the third embodiment.

### The Fourth Embodiment

The fourth embodiment involves optimization of matching of the antenna structure according to the present invention.

In the initial matching phase of research and development of an antenna, it is necessary to work out different matching schemes for the same antenna pattern. It is possible to conveniently obtain the optimal matching schemes for different antennas by the matching method according to this embodiment.

In this embodiment, an antenna body including a main antenna and a parasitic antenna is prepared first. A matching element is disposed on the antenna body so that an end of the matching element is connected to a conductor strip of the main antenna, and the other end is connected to a conductor strip of the parasitic antenna. The matching element is initially disposed at a predetermined initial position, the characteristics of the antenna, such as return loss, is measured, then the connection position of the matching element is sequentially changed by a predetermined amount to measure the characteristics of the antenna.

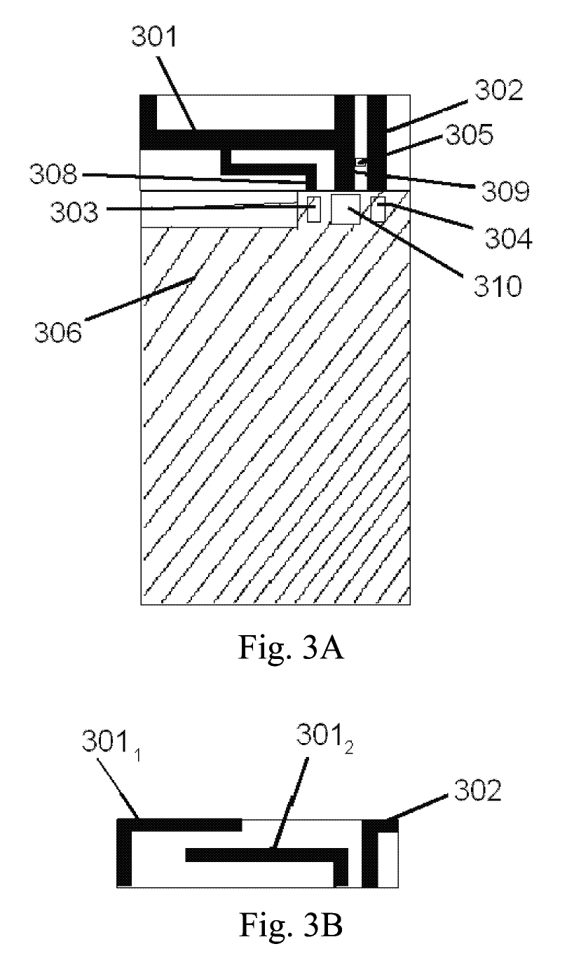

FIG. 4A shows an example, there is a total length of 8 mm from an upper edge to a lower edge of the antenna base, with the lower edge being set as starting point 0 mm, then distance from the matching element to the lower edge is changed. Of the three positions shown in FIG. 4A, position 401 is 1 mm, position 402 is 4 mm, and position 403 is 7 mm.

FIG. 4B shows the measurement results of return losses when the matching element is respectively disposed at the three positions. Curve 410 indicates the measurement result of return loss when the matching element is disposed at position 401, curve 411 indicates the measurement result of return loss when the matching element is disposed at position 402, and curve 412 indicates the measurement result of return loss when the matching element is disposed at position 403.

As can be seen from FIG. 4B, as the position of the matching element is changed, the curve indicating return loss of the antenna varies regularly in the DCS band. Thus, the optimal position of the matching element can be conveniently determined after several rounds of such tests, therefore an optimized matching structure can be determined.

### The Fifth Embodiment

Like the aforementioned fourth embodiment, the fifth embodiment also involves optimization of matching of the antenna structure according to the present invention.

Unlike the fourth embodiment, the characteristic value of the matching element is changed to perform the matching optimization in the fifth embodiment.

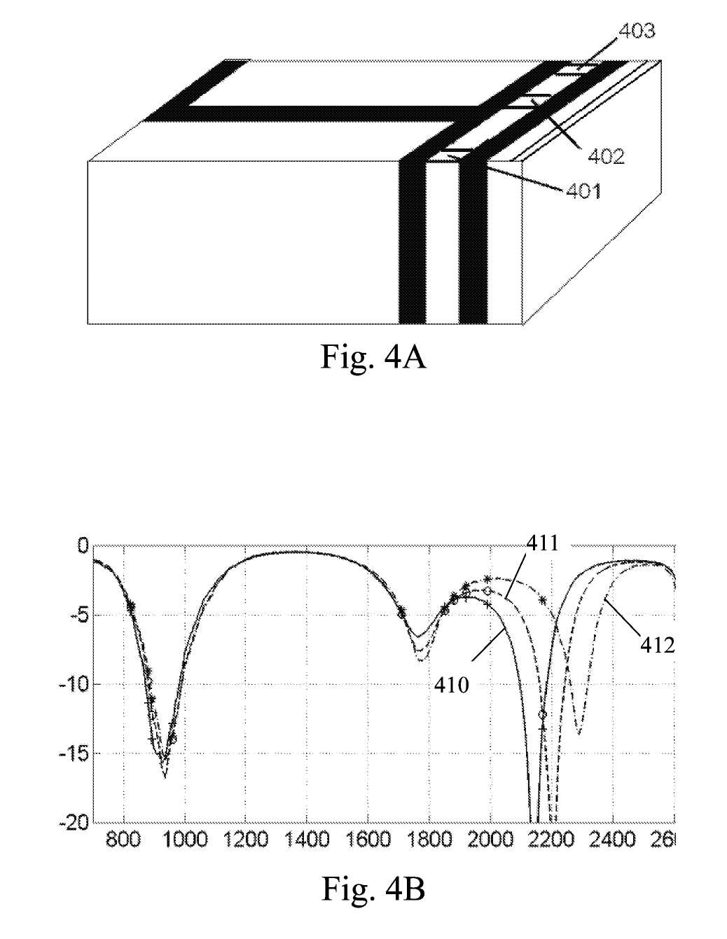

In the fifth embodiment, an inductor having different inductance of respectively 6.8 nh, 8.2 nh, 10 nh and 12 nh is soldered onto the main antenna and the parasitic antenna. The return loss of the antenna is measured under each of these inductances. FIG. 5 shows the measurement results of the return losses of the antenna when the matching element is under different values, wherein curve 501 indicates the return loss when the inductive value is 6.8 nh, curve 502 indicates the return loss when the inductive value is 8.2 nh, curve 503 indicates the return loss when the inductive value is 10 nh, and curve 504 indicates the return loss when the inductive value is 12 nh. As can be seen from FIG. 5, as the inductance is increased, the curve at low frequency side gradually becomes deep, as to the two harmonic waves generated at the high frequency side, the changing tendency in DCS band is the same as at the low frequency side, while in UMTS band, the curve not only becomes deeper but also somehow shifts to the low-frequency direction.

As mentioned above, an antenna body including a main antenna element and a parasitic antenna element is prepared first. A matching element is disposed on the antenna body so that an end of the matching element is connected to a conductor strip of the main antenna element, and the other end is connected to a conductor strip of the parasitic antenna element. The inductance of the matching element is initially set as a predetermined initial value, return loss of the antenna is measured, then the inductance of the matching element is sequentially changed by predetermined amount to respectively measure the characteristics of the antenna. The optimal value of the matching element can be conveniently determined based on the measurement results of return loss of the antenna under different inductances, so as to conveniently determine an optimized matching structure of the antenna.

### Modified Embodiments

Some embodiments of the present invention are explained above. It would be understood, however, that the present invention is not limited to these embodiments, and can be modified within the range of the substantive principle of this invention.

For instance, the matching element is exemplarily described as an inductor in the aforementioned embodiments, but the present invention is not limited thereto, as the matching element can as well be a capacitor, a high pass filter, or a low pass filter, etc.

The number of the matching element is exemplified as one in the aforementioned embodiments to facilitate comprehension. But the present invention is not limited thereto, as a combination of the elements can also be employed upon actual circumstances. For instance, in the case there is a sufficient distance between the main antenna element and the parasitic antenna element, a combination of a plurality of inductor elements connected in parallel or in series, or a combination of a plurality of capacitor elements connected in parallel or in series, or a combination of an inductor and a capacitor connected in parallel or in series can also be used.

In the aforementioned embodiments, the characteristic value of the matching element is exemplified as the inductance of an inductor. But the present invention is not limited thereto, as the characteristic value can be capacitance in the case of using a capacitor, and can be cut-off frequency of a filter in the case of using a high pass filter or a low pass filter.

In the aforementioned embodiments, the matching element is disposed on a surface of the antenna at a position from up to down between the main antenna element and the parasitic element. But the present invention is not limited thereto, as the matching element can be disposed at an arbitrary position from left to right in the case the parasitic element is transversely arranged, and this depends entirely on the lengths of the main antenna element and the parasitic element.

In addition, in the fourth and fifth embodiments it is described that position or value alone of the matching element is adjusted to determine the optimal matching structure of the antenna. However, the optimal matching structure of the antenna can also be determined by simultaneously adjusting the position and the value of the matching element.

According to the present invention, it is possible to lower the difficulty degree of the matching, improve the return loss in low frequency, hence improve the antenna efficiency in the low frequency, enhance the bandwidth in the high frequency, hence enhance the efficiency in the high frequency, and particularly enhance the impedance matching and the width of the frequency bands at the DCS waveband.

Furthermore, it is easy to make different matching schemes for the same antenna pattern during the initial matching phase in the research and development stage of the antenna, and it is also possible to conveniently make different matching schemes for different antennas under the same model of wireless device.

Additionally, the demand on the space for the circuit board is also reduced.

1.-16. (canceled)

17. An antenna for a wireless device comprising:
a main antenna element;
a parasitic antenna element separated from the main antenna element; and
a matching element connected between the main antenna element and the parasitic antenna element.

18. The antenna of claim 17, wherein an end of the matching element is electrically connected to a conductor strip of the main antenna element, and the other end of the matching element is electrically connected to a conductor strip of the parasitic antenna element.

19. The antenna of claim 17, wherein the matching element comprises an inductor.

20. The antenna of claim 17, wherein the matching element comprises a capacitor.

21. The antenna of claim 17, wherein the matching element comprises a series and/or parallel combination of one or more inductors and one or more capacitor.

22. The antenna of claim 17, wherein the matching element comprises a high pass filter.

23. The antenna of claim 17, wherein the matching element comprises a low pass filter.

24. The antenna of claim 17, wherein position of the matching element is determined so that the antenna obtains an optimized return loss.

25. The antenna of claim 17, wherein characteristic value of the matching element is determined so that the antenna obtains an optimized return loss.

26. The antenna of claim 17, wherein the main antenna element comprises a monopole antenna.

27. The antenna of claim 17, wherein the main antenna element comprises an inverted F antenna.

28. A wireless device comprising the antenna of claim 17.

29. A method of matching an antenna for a wireless device, the method comprising:
changing parameter of a matching element on an antenna unit that includes a main antenna element and a parasitic antenna element separated from the main antenna element, the matching element having an end electrically connected to the main antenna element and another end electrically connected to the parasitic antenna element;
measuring an antenna characteristic respectively at different parameters; and
determining the best parameter for the matching element based on the measured antenna characteristic.

30. The method of claim 29, wherein the parameter is position of the matching element.

31. The method of claim 29, wherein the parameter is characteristic value of the matching element.

32. The method of claim 29, wherein the parameter is position and characteristic value of the matching element.

33. The method of claim 29, further comprising preparing the antenna unit having the main antenna element and the parasitic antenna element.

34. The method of claim 29, further comprising providing the matching element on the antenna unit.

35. The method of claim 29, wherein:
the parameter comprises position and/or characteristic value of the matching element; and/or
the measured antenna characteristic is return loss.

36. The method of claim 29, wherein:
the matching element comprises at least one or more of an inductor, a capacitor, a high pass filter, and/or a low pass filter; and/or
the main antenna element comprises a monopole antenna or an inverted F antenna.
